(19) United States
(12) Patent Application Publication
(10) Pub. No.: US 2010/0270399 A1
(43) Pub. Date: Oct. 28, 2010

(54) DISPENSER AND A METHOD OF FILLING A LIQUID ADDITIVE CONTAINER

(75) Inventors: Christopher P. Chambers, Auckland (NZ); Paul S. Hood, Auckland (NZ); Nathan P. Strong, Auckland (NZ)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: METHVEN LIMITED, Avondale, Auckland (NZ)

(21) Appl. No.: 12/734,168

(22) PCT Filed: Oct. 16, 2008
(86) PCT No.: PCT/NZ2008/000273

§ 371 Date: Jul. 2, 2010

(30) Foreign Application Priority Data
Oct. 16, 2007 (NZ) 562573

(51) Int. Cl. B01F 5/00; B05B 7/24; B67C 3/16; B65B 3/04; E03C 1/046

(52) U.S. Cl. 239/318; 141/7

(57) ABSTRACT

A dispenser (100) has a base (1) engagable with a liquid additive container (2) by relative movement of the container (2) toward the base (1) along an engagement axis (E). The container (2) has an inlet port (12) and an outlet port (21). The dispenser (100) is provided with a main flow passage (18) and a main flow restricting means (19). The base (1) is provided with an outlet means (11) which communicates with the inlet port (12) and an inlet conduit (20) connecting the main flow passage (18) with the outlet means (11). The base (1) is provided with an inlet means (22A) which communicates with the outlet port (21) and an outlet conduit (22) connecting the main flow passage (18) with the inlet means (22A). At least one of the inlet means (22A) and the outlet means (11) of the base (1) are provided in a surface (9A) of the base (1) which is substantially parallel to the engagement axis (E).

### TECHNICAL FIELD

The present invention relates to methods and apparatus for dispensing liquid additives to a fluid flow, and in particular, but not exclusively, to methods and apparatus for adding soaps, skin conditioners and the like to a stream of water which supplies a shower head.

### BACKGROUND TO THE INVENTION

The prior art has many examples of apparatus for adding soap to a stream of water which supplies a shower head.

Some systems create a pressure drop in the main water supply to the shower. Water from the high pressure side is taken to a container which contains the additive. The mixed water and additive is reintroduced to the lower pressure side of the pressure drop. In U.S. Pat. No. 4,121,773 the pressure drop is created by a venturi, whereas in U.S. Pat. No. 5,333,789 the pressure drop is created by a baffle. U.S. Pat. No. 5,333,789 states that there is very little mixing of the water and additive in the canister, but there is no mention of deliberately separating the water from the additive.

A problem with systems of this type is that a stream of water flows through the container in which the additive is held. This results in variations in the amount of additive which is added to the water stream, and there is no way of determining how much additive is left in the container.

Some other systems store the additive in a flexible container which is able to deform as the volume of additive in it decreases. The flexible container prevents any mixing of the additive and the water within the unit. U.S. Pat. No. 3,166,096 and U.S. Pat. No. 3,974,847 are examples of this type of system.

These systems go some way to overcoming the problems mentioned above. However, storing the additive in flexible containers may be inconvenient, and replacement of the flexible containers may be difficult and time consuming.

It would be advantageous to provide a system in which the amount of additive dispensed into the water stream is consistent, and preferably controllable, and where changing or swapping the containers carrying the additive is quick and convenient.

### OBJECT OF THE INVENTION

It is an object of a preferred embodiment of the invention to provide a dispenser for dispensing a liquid additive into a stream of liquid which will overcome or ameliorate problems with such dispensers at present, or at least one which will provide the public with a useful choice.

It is an alternative object to provide a method of filling a liquid additive container which will overcome or ameliorate problems with such methods at present, or at least one which will provide the public with a useful choice.

Other objects of the present invention may become apparent from the following description, which is given by way of example only.

### BRIEF SUMMARY OF THE INVENTION

According to, a first aspect of the present invention there is provided a dispenser for dispensing a liquid additive into a stream of liquid, the dispenser including a base engageable in use with a liquid additive container by relative movement of the liquid additive container toward the base along an engagement axis, the liquid additive container including an inlet port and an outlet port, the dispenser provided with a main flow passage for the stream of liquid, the main flow passage having a main flow inlet, a main flow outlet, and a main flow restricting means between the main flow inlet and the main flow outlet, the base provided with an outlet means and an inlet conduit connecting the main flow passage, between the main flow inlet and the main flow restricting means, with the outlet means, the base further provided with an inlet means and an outlet conduit connecting the main flow passage, between the main flow outlet and the main flow restricting means, with the inlet means, wherein the inlet port is adapted to communicate with the outlet means and the outlet port is adapted to communicate with the inlet means when the base and liquid additive container are engaged, and wherein at least one of the inlet means and the outlet means of the base are provided in a surface of base which is substantially parallel to the engagement axis.

Preferably the outlet means is provided in a surface of the base which is substantially parallel to the engagement axis.

Preferably both the inlet means and the outlet means are provided in a surface of the base which is substantially parallel to the engagement axis.

Preferably one of the liquid container and base is provided with a socket and the other of the base and the liquid container is provided with an engagement portion adapted to engage the socket by relative movement of the engagement portion toward the socket along the engagement axis.

Preferably the restriction caused by the main flow restricting means is adjustable.

Preferably the main flow restricting means includes a rotatable vane.

Preferably the flow restricting means is substantially removable from the main flow path.

According to a second aspect of the present invention there is provided a liquid container adapted for use with the dispenser of the first aspect.

Preferably the liquid container is provided with a dividing member which is slideably and sealingly engaged with an inner surface of the liquid container, the dividing member provided between the inlet port and the outlet port.

Preferably the liquid container provided with a plurality of inlet ports.

According to a third aspect of the present invention there is provided a dispenser for dispensing a liquid additive into a stream of liquid, the dispenser provided with a main flow passage for the stream of liquid, the main flow passage having a main flow inlet, a main flow outlet, and a main flow restricting means between the main flow inlet and the main flow outlet, the dispenser provided with a first chamber for containing the liquid additive, the first chamber having a first volume, an inlet conduit connecting the main flow passage, between the main flow inlet and the main flow restricting means, with the first chamber, the inlet conduit having a second volume which is greater than said first volume, and an outlet conduit connecting the first chamber with the main flow passage, between the main flow outlet and the main flow restricting means, wherein, in use, fluid from the main flow passage entering the inlet conduit forces air in the inlet conduit into the first chamber, thereby displacing the liquid additive through the outlet conduit.

Preferably substantially all of a liquid additive contained in the first chamber is displaced from the first chamber before the first conduit is completely filled with fluid from the main flow passage.

Preferably the dispenser includes a base engageable with a liquid additive container, wherein the first chamber is provided in the liquid additive container and the main flow passage is provided in the base.

Preferably the restriction caused by the main flow restricting means is adjustable.

Preferably the flow restricting means is removable from the main flow path.

According to a fourth aspect of the present invention there is provided a dispenser for dispensing a liquid additive into a stream of liquid, the dispenser including a base engageable in use with a liquid additive container by relative movement of the liquid additive container toward the base along an engagement axis, the liquid additive container provided with a first chamber for containing the liquid additive, the dispenser provided with a main flow passage for the stream of liquid, the main flow passage having a main flow inlet, a main flow outlet, and a main flow restricting means between the main flow inlet and the main flow outlet, the base provided with an outlet means and an inlet conduit connecting the main flow passage, between the main flow inlet and the main flow restricting means, with the outlet means, the base further provided with an inlet means and an outlet conduit connecting the main flow passage, between the main flow outlet and the main flow restricting means, with the inlet means, the liquid container including an inlet port adapted to communicate with the outlet means when the base and liquid container are engaged, and an outlet port adapted to communicate with the inlet means when the base and liquid container are engaged, wherein at least one of the inlet means and the outlet means of the base are provided in a surface of base which is substantially parallel to the engagement axis, and wherein a volume of the inlet conduit is greater than a volume of the first chamber.

Preferably, in use, substantially all of a liquid additive contained in the first chamber is displaced from the first chamber before the inlet conduit is completely filled with fluid from the main flow passage.

Preferably the restriction caused by the main flow restricting means is adjustable.

Preferably the flow restricting means is removable from the main flow path.

According to a fifth aspect of the present invention there is provided a method of filling a liquid additive container having a chamber, an inlet port and an outlet port connected to the chamber and a dividing member which is slideably and sealingly engaged with an inner surface of the liquid container between the inlet port and the outlet port, the method including the steps of:
i. applying a vacuum to the outlet port;
ii. maintaining the vacuum until the dividing means has moved to a position wherein the volume of the chamber between the dividing means and the outlet port is minimised;
iii. inserting a required volume of liquid additive into the chamber through the outlet port.

Preferably the method includes the step of sealing the inlet and outlet ports after the step of inserting the required volume of liquid additive is complete.

Preferably the step of sealing the inlet and outlet ports is performed by sealing with a single sealing means.

According to a further aspect of the present invention there is provided a dispenser substantially as herein described, with reference to FIG. 1, FIG. 2 or FIGS. 7 to 10.

According to a still further aspect of the present invention there is provided a method of filling a liquid additive container substantially as herein described with reference to FIGS. 3 to 6.

Further aspects of the invention, which should be considered in all its novel aspects, will become apparent from the following description given by way of example of possible embodiments of the invention.

### BRIEF DESCRIPTION OF THE DRAWINGS

FIG. 1: Is a diagrammatic cross-section drawing of a dispenser according to one possible embodiment of the present invention.

FIG. 2: Is a diagrammatic cross-section drawing of a dispenser according to a second possible embodiment of the present invention.

FIG. 3: Is a diagrammatic cross-section drawing of a liquid additive filling apparatus engaged with a liquid container.

FIG. 4: Shows the liquid additive filling apparatus of FIG. 3 having drawn the piston of the liquid container to a position of minimum volume.

FIG. 5: Shows the liquid additive filling apparatus of FIGS. 3 and 4 in use filling the liquid container with liquid additive.

FIG. 6: Shows a liquid additive cartridge.

FIG. 7: Shows a side perspective view of an alternative embodiment of the dispenser shown in FIG. 1.

FIG. 8: Shows a side perspective view of the dispenser shown in FIG. 7 with the outer housing and cartridge removed for clarity.

FIG. 9: Shows an enlarged cross section view of the socket and flow restricting means of the embodiment shown in FIG. 7.

FIG. 10: Shows a perspective view of the flow restricting means and activation mechanism.

### BEST MODES FOR PERFORMING THE INVENTION

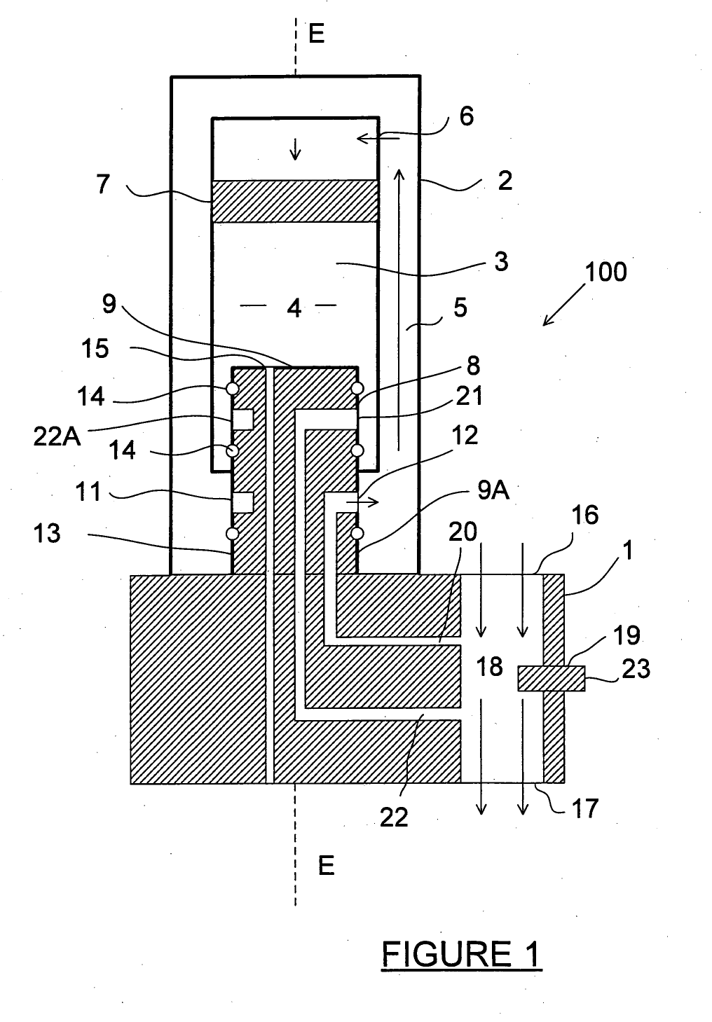

Referring first to FIG. 1, a dispenser is generally referenced by arrow 100. The dispenser includes a base 1 and a liquid additive container 2, hereinafter referred to as a cartridge.

The cartridge 2 includes a chamber 3 within which a dispensable liquid 4 is contained. In the embodiment shown the chamber 3 is provided inside an outer chamber 5, although in other embodiments (not shown) a simple conduit may replace the outer chamber 5.

The inner chamber 3 is in fluid communication with the outer chamber 5 via one or more ports 6. A dividing member, typically in the form of a piston 7, is slideably and sealingly engaged with the inside wall of the inner chamber 3. The piston 7 is provided between the ports 6 and the dispensable liquid 4, thereby separating the dispensable liquid 4 from any fluid entering though the ports 6.

The lower portion of the cartridge 2 defines a socket 8 into which a protruding engagement portion of the base 1 such as a substantially cylindrical boss 9 can be inserted by moving the cartridge 2 and base 1 together along an engagement axis E, to thereby engage the cartridge 2 with the base 1.

The engagement portion 9 of the base 1 is provided with an outlet means 11 which is in fluid communication with one or more inlet ports 12 provided though an inner wall 13 of the socket 8. The outlet means 11 may be one or more ports, but in the preferred embodiment shown the outlet means 11 is an annular groove. The use of an annular grove 11 means that there is no need to provide a means of indexing the outlet means 11 with the inlet ports 12, and so the dispenser 100 will operate regardless of the angular position of the cartridge 2 relative to the base 1.

Suitable sealing means such as O-ring seals 14 are provided around the boss 9 to create a seal around the interface between the outlet means 11 and inlet ports 12. In a preferred embodiment a vent 15 is provided from the upper surface of the boss 9 to release any air and/or liquid which is trapped between the top O-ring seal 14 and the cartridge 2 when the cartridge 2 is engaged with the base 1.

In use, the stream of water to which the dispensable liquid 4 is to be added flows from a main inlet 16 to a main outlet 17 via a main flow path 18. A flow restrictor 19 is provided in the main flow path 18. The flow restrictor 19 increases the pressure of the flow upstream, that is, between the restrictor 19 and the main inlet 16, and decreases the pressure of the flow downstream, that is, between the flow restrictor 19 and the main outlet 17. An inlet conduit 20 extends from the main flow path 18, upstream of the flow restrictor 19, to the outlet means 11. The pressure of the fluid upstream of the flow restrictor 19 acts on the top surface of the piston 7, via inlet conduit 20, outlet means 11, inlet port 12, outer chamber 5 and ports 6. The piston 7 moves toward the base 1, thereby displacing the dispensable liquid 4 though an orifice 21 in the inner chamber 3. The dispensable liquid 4 flows from the orifice 21 through an outlet conduit 22 via an inlet means 22A and enters the main flow path 18 in the lower pressure flow downstream of the flow restrictor 19.

O-ring seals 14 are also provided to prevent fluid escaping from the interface between the orifice 21 and the inlet means 22A.

Because the inner wall 13 and the sides 9A of the boss 9 are substantially parallel to the engagement axis E, the pressure of the liquid flowing between the outlet means 11 and the inlet ports 12 creates a force which is orthogonal to the engagement axis E, as does the pressure of the fluid flowing from the orifice 21 to the inlet means 22A. In this way the friction created between the O-ring seals 14 and the inner wall 13 may be sufficient to hold the cartridge 2 in engagement with the base 1, without any further holding means being required. This may allow for particularly easy and convenient replacement of the cartridge 2.

The rate at which the dispensable liquid 4 is dispensed into the main flow path 18 varies with the flow rate of the fluid in the main flow path. However, the rate may be also be controlled by varying the pressure drop caused by the flow restrictor 19, and/or by restricting the flow in the inlet conduit 20 and/or outlet conduit 22, for example by use of suitable needle valves or the like (not shown).

In one embodiment the flow restrictor 19 may have a fixed diameter, with the rate at which the dispensable liquid 4 is dispensed being varied by suitable valving in the inlet or outlet conduits. However, in an alternative embodiment the flow restrictor 19 may include a slideable member 23 which can be remotely inserted into or withdrawn from the main flow path 18. With the slideable member 23 fully withdrawn from the main flow path 18 there is little or no pressure difference between the inlet conduit 20 and the outlet conduit 22, and the dispenser 100 is thereby deactivated. The slidable member 23 thereby provides a means of activating or deactivating the dispenser, and/or of varying the rate at which the liquid 4 is dispensed.

The rate at which the dispensable liquid 4 is dispensed may also be varied by varying the diameter of the orifice 21. However, it is preferred that the orifice 21 remain a constant diameter which is selected to be sufficiently small that the surface tension of the dispensable liquid 4 substantially prevents leakage of the dispensable liquid 4 when there is no pressure on the piston 7, but allows the piston 7 to displace the dispensable liquid 4 when under pressure. In this way no cap or stop need be used to prevent leakage of the dispensable liquid if the cartridge 2 is temporarily removed from the base 1.

In a preferred embodiment, intended for use in dispensing a soap based infusion to a domestic shower system, the dispenser may have approximate dimensions as follows:

Cross section area of main flow path 17=50 mm²
Cross section area of main flow path at main flow restrictor 18 (minimum)=approx 25 mm² (approx 50% of unrestricted flow path)
Volume of inner chamber 3=40 ml
Diameter of piston 7=approx 20 mm
Diameter of orifice 20=1 mm.

This embodiment dispenses the dispensable fluid 4 at a rate of approximately 1 ml per minute though the main flow path 18, assuming the dispensable liquid has a viscosity of around 500 cps and the liquid flowing through the main flow path 18 is water which is flowing at the maximum flow rate of around 13 litres per minute allowed by the 25 mm² restrictor.

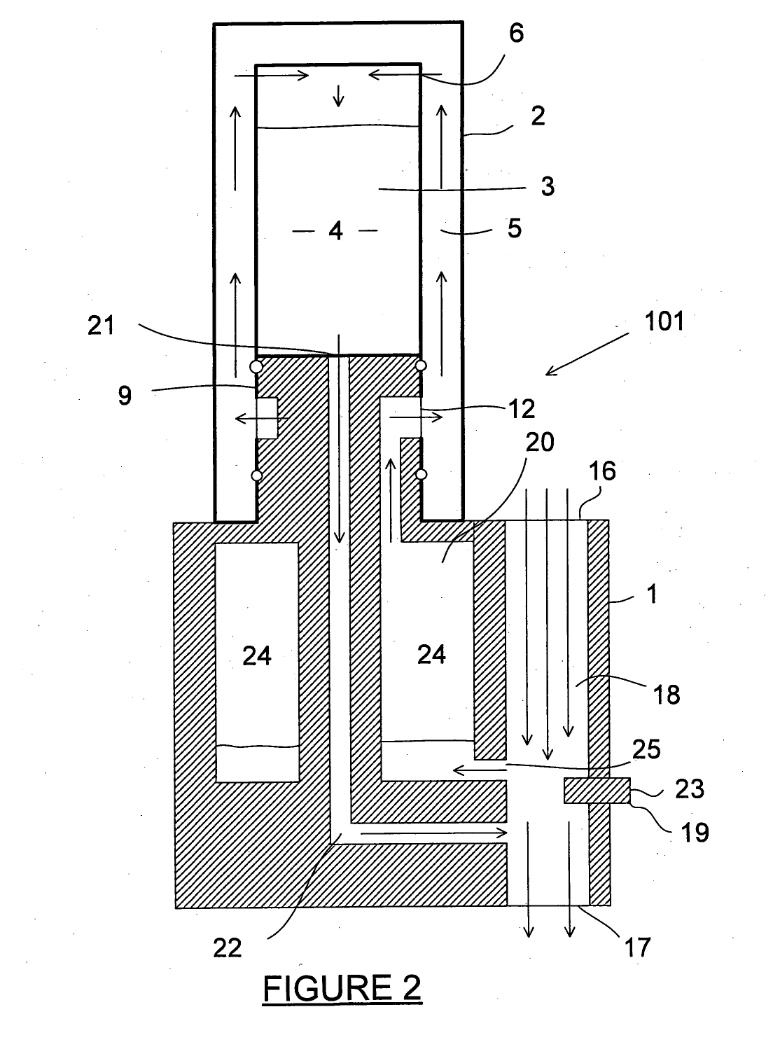

Referring next to FIG. 2, in which similar reference numerals denote similar features to FIG. 1, an alternative embodiment of the dispenser is generally referenced 101.

In common with the dispenser 100, the dispenser 101 includes a base 1 and a cartridge 2.

The cartridge 2 includes an outer chamber 5 within with an inner chamber 3 is provided. The inner chamber 3 contains a dispensable liquid 4.

The inner chamber 3 is in fluid communication with the outer chamber 5 via one or more ports 6. However, in this embodiment the piston 7 used in the embodiment shown in FIG. 1 is not required.

In the second embodiment 101 the inlet conduit 20 is enlarged so that it has a volume at least equal to the volume of the inner chamber 3. In the embodiment shown the additional volume is created by provision of a void space or chamber 24 inside the base 1.

When the dispenser 101 is held in its intended orientation, the opening 25 of the inlet conduit 20 into the main flow path 18 is preferably the lowest point of the inlet conduit 20. In this way the inlet conduit 20, including the chamber 24, may drain into the main flow path 18 when the dispenser is not in use, ensuring that the inlet conduit is substantially empty of liquid when a user activates the dispenser 101. Of course, it is preferred that the arrangements of the flow paths within the base and/or cartridge be such that the dispensable liquid 4 in the inner chamber 3 is not able to drain through the inlet conduit 20 in the same way.

Upon activation, the inlet conduit 20 begins to fill with water from the main flow path 18, upstream of the restrictor 19. The ingress of the water into the inlet conduit 20 raises the pressure of the air in the conduit 20. The increased pressure is transmitted to the top of the dispensable fluid 4 in the inner chamber 3, and is sufficient to force the fluid 4 out of the orifice 21, through the outlet conduit 22 and into the main flow path 18 downstream of the restrictor 19. In the embodiment shown the orifice 21 is provided on a surface which is orthogonal to the engagement axis E, but in other embodiments the orifice 21 may be provided in the inner surface 13, as is described above in relation to FIG. 1.

Because the volume of the inlet conduit 20 is greater than the volume of the inner chamber 3, substantially all of the dispensable fluid 4 is forced out of the inner chamber 3 before the inlet conduit 20 fills completely with water. In this way the dispensable fluid 4 is dispensed into the main flow path 18 without any mixing of the water and the dispensable liquid occurring in the inner chamber 3.

In a further embodiment (not shown) the inlet conduit 20 may have a volume which is less than that of the inner chamber 3, but the outer chamber 5 may have a sufficiently large volume to ensure that all of the dispensable fluid is forced out of the inner chamber 3 before the water reaches ports 6.

In a further variation of the dispenser 101 (not shown) the base 1 and cartridge 2 may be an integral unit, rather than being removably engageable. Such an embodiment may be intended as a single use disposable item, or it may include a means of refilling the chamber 3 with further dispensable fluid.

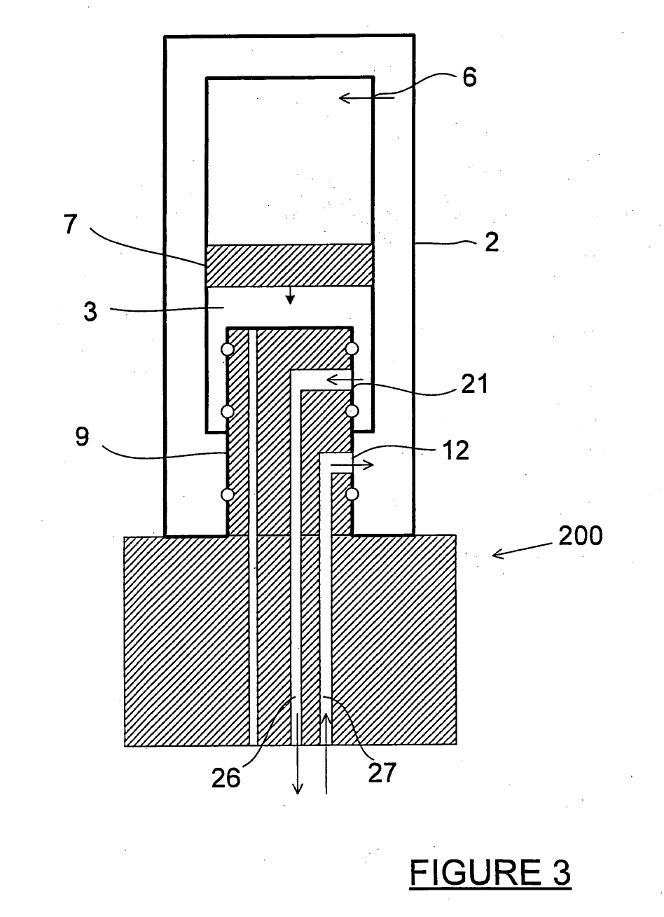

FIGS. 3 to 6 illustrate a method of filling or refilling a cartridge 2 having a piston 7 or other dividing means, such as the one described above with reference to FIG. 1.

The cartridge 2 may be engaged with a filling apparatus 200 which has a boss 9 provided with a first port 26 adapted to communicate with the orifice 21 and a second port 27 adapted to communicate with the inlet port 12. The size and position of the boss 9, first port 26 and second port 27 may be substantially identical to the corresponding features on the base 1 shown in FIG. 1.

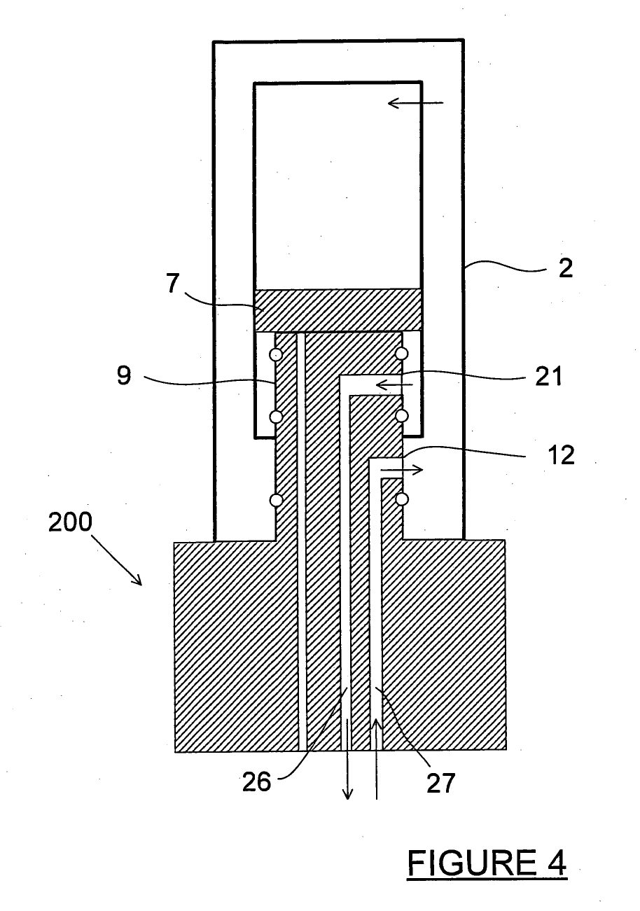

Referring to FIG. 3, prior to filling the cartridge 2, a vacuum may be applied to the orifice 21 though the first port 26. The vacuum may be maintained until the piston 7 moves as far as is possible towards the orifice 21, as shown in FIG. 4, thereby expelling any remaining dispensable liquid from the inner chamber 3. Air, or any other suitable gas, may be drawn through the second port 27 and inlet port 12 and into the space above the piston 7.

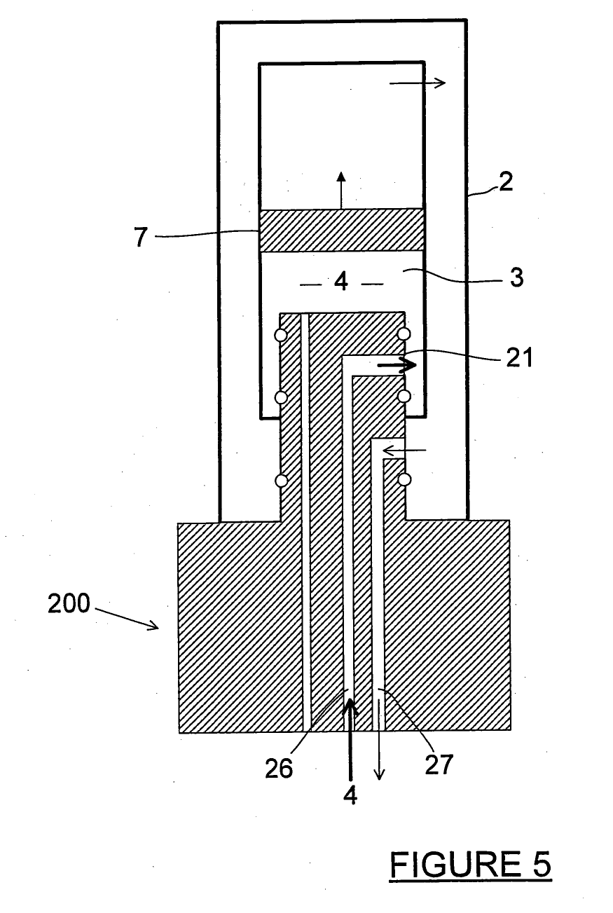

Once the piston 7 has moved as far as possible towards the orifice 21, a required amount of the dispensable liquid 4 can be inserted into the inner chamber 3 through the first port 26 and orifice 21, as shown in FIG. 5. Any liquid remaining in the outer chamber 5 is expelled though the second port 27 as the piston 7 moves away from the orifice 21.

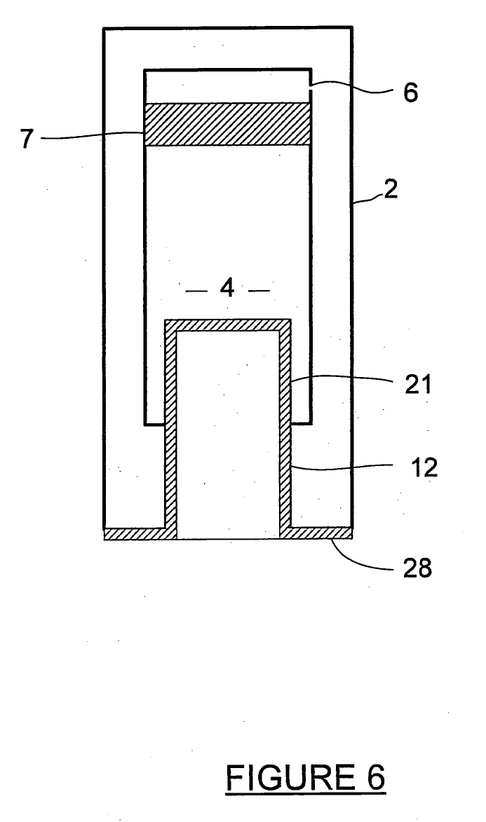

Referring in particular to FIG. 6, once filled, the cartridge 2 is preferably sealed with a suitable sealing means, such as a stopper or bung 28, which covers both the inlet port 12 and the orifice 21, thereby preventing accidental leakage of the dispensable liquid 4 when the cartridge 4 is not in use.

In some embodiments (not shown) the base 1 of the dispenser 100 may be adapted to allow refilling of cartridges by the user.

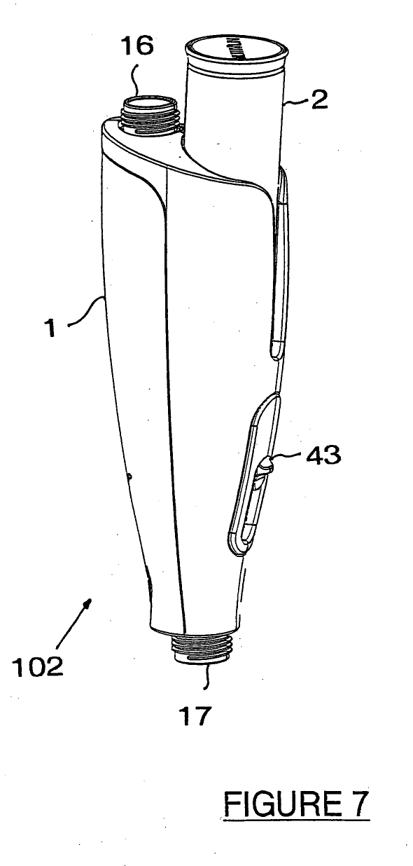

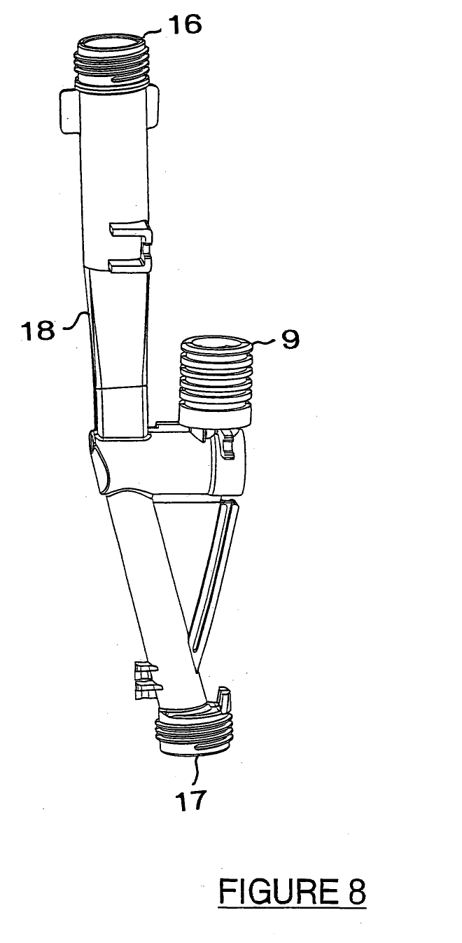

FIGS. 7 to 10 show an alternative embodiment of the dispenser, generally referenced 102, in which similar reference numerals denote similar features to FIG. 1. The main inlet 16 and main outlet 17 are preferably provided with threaded fittings to allow attachment to a standard shower hose, although other means of connecting the dispenser to a supply of water may be used.

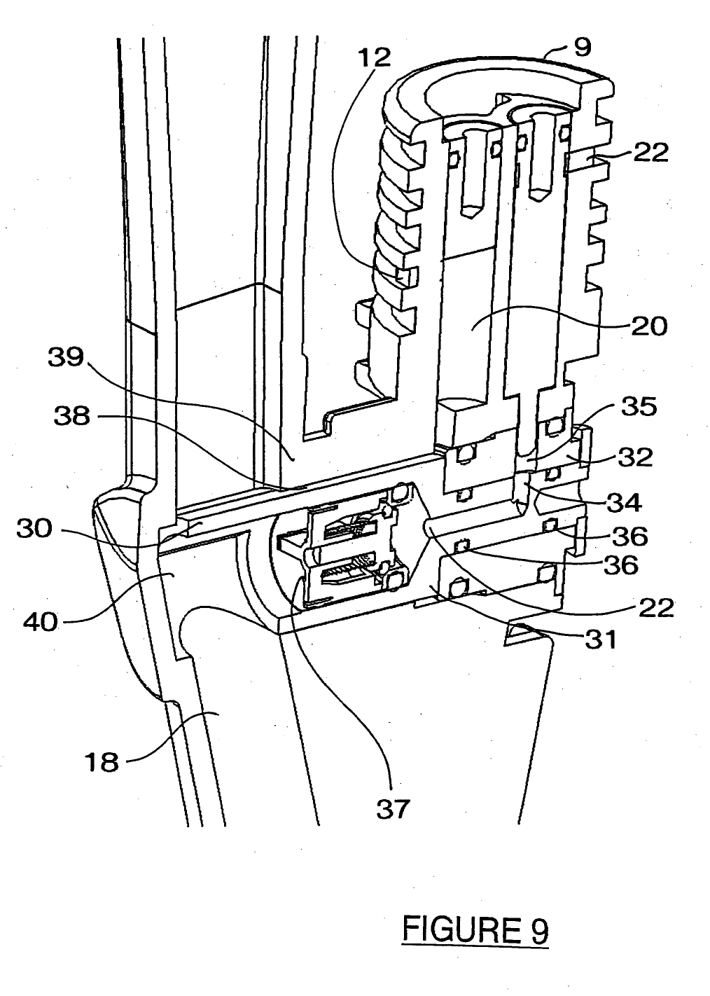

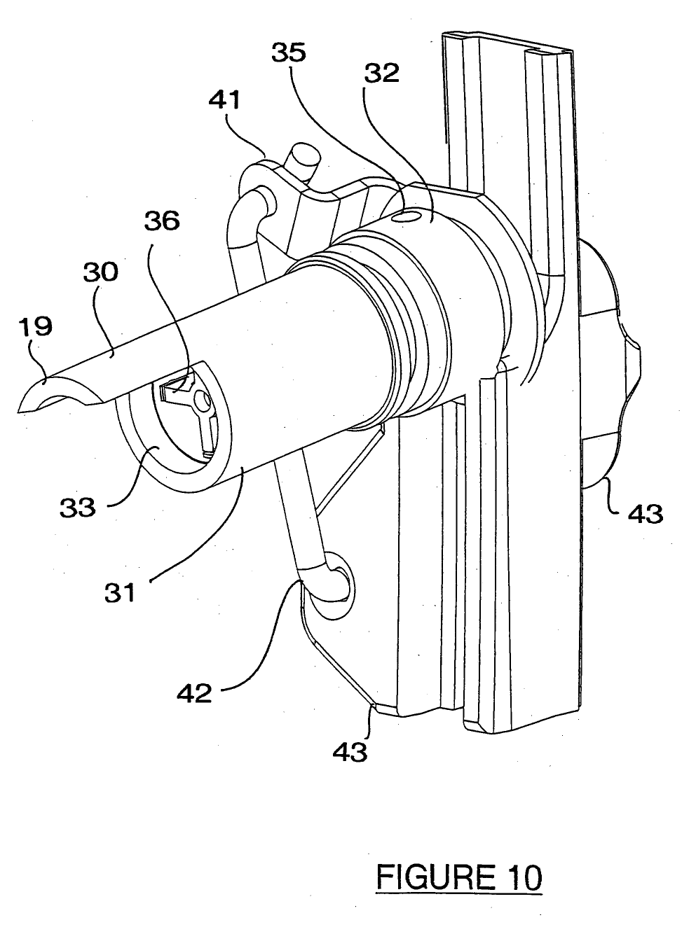

Referring in particular to FIGS. 9 and 10, in a preferred embodiment the flow restrictor 19 may be a rotatable vane 30. In the embodiment shown, the vane 30 is provided as a formation which is integral with a rotatable member 31. The rotatable member 31 has an exterior shape which, excluding the vane, is a surface of revolution. The rotatable member is rotatably engaged with a bush 32. The vane 30 is preferably offset from the axis of rotation of the rotatable member 31.

A portion of the outlet conduit 22 may be provided within the rotatable member 31. In a preferred embodiment the conduit 22 may extend along the central axis of the rotatable member 31, with the outlet 33 of the outlet conduit 22 provided adjacent the vane 30. The conduit 22 may include a portion 34 which extends radially from the central axis. The radial portion 34 may be adapted to align with an aperture 35 in the bush 32 when the rotatable member 31 is rotated into the “in use” position shown in FIG. 9, thereby allowing the dispensable liquid to flow through the conduit in the rotatable member 31. When the rotatable member 31 is rotated away from the in use position, the radial portion 34 moves out of alignment with the aperture 35 in the bush 32. O-ring seals 36 are provided on each side of the radial portion 34.

A one way valve 37 may be provided within the rotatable member 31 to prevent back flow of water up the outlet conduit 22.

The inlet conduit 20 may include a channel 38 provided between the body 39 of the dispensing means and the rotatable member 31.

The main flow path 18 may include a scalloped portion 40 into which the vane 30 moves when not in use. In this way the vane 30 does not impede the flow through the main flow path 18 when the dispenser is not in use.

Referring next to FIGS. 7 and 10, movement of the rotatable member 31 and the vane 30 may be achieved by any suitable means, but in a preferred embodiment the rotatable member 31 is provided with a crank arm 41. A connecting rod 42 connects the crank arm 41 to a slider 43 provided, on the exterior of the dispenser body, so that movement of the slider 43 by the user rotates the rotatable member 30 and the vane 31 between the “in use” position shown in FIG. 9 and the “off” position (not shown) wherein the vane 30 is rotated substantially out of the path of the fluid flowing through main flow path 18.

While the embodiments described above show the base 1 provided with a protruding engagement portion 9 and the cartridge 2 provided with the socket, those skilled in the art will appreciate that in other embodiments (not shown) the cartridge may be provided with a protruding engagement portion and the base 1 with a socket.

While the present invention has been described with reference to preferred embodiments which are intended for use in adding a dispensable liquid to a shower, those skilled in the art will appreciate that the invention may also be useful for adding liquids to other liquid flows.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the appended claims.

1. A dispenser for dispensing a liquid additive into a stream of liquid, the dispenser including a base engageable in use with a liquid additive container by relative movement of the liquid additive container toward the base along an engagement axis, the liquid additive container including an inlet port and an outlet port, the dispenser provided with a main flow passage for the stream of liquid, the main flow passage having a main flow inlet, a main flow outlet, and a main flow restricting means between the main flow inlet and the main flow outlet, the base provided; with an outlet means and an inlet conduit connecting the main flow passage, between the main flow inlet and the main flow restricting means, with the outlet means, the base further provided with an inlet means and an outlet conduit connecting the main flow passage, between the main flow outlet and the main flow restricting means, with the inlet means, wherein the inlet port is adapted to communicate with the outlet means and the outlet port is adapted to communicate with the inlet means when the base and liquid additive container are engaged, and wherein at least one of the inlet means and the outlet means of the base are provided in a surface of base which is substantially parallel to the engagement axis.

2. The dispenser of claim 1, wherein the outlet means is provided in a surface of the base which is substantially parallel to the engagement axis.

3. The dispenser of claim 1, wherein both the inlet means and the outlet means are provided in a surface of the base which is substantially parallel to the engagement axis.

4. The dispenser of claim 1, wherein one of the liquid container and base is provided with a socket and the other of the base and the liquid container is provided with an engagement portion adapted to engage the socket by relative movement of the engagement portion toward the socket along the engagement axis.

5. The dispenser of claim 1, wherein the restriction caused by the main flow restricting means is adjustable.

6. The dispenser of claim 5, wherein the main flow restricting means includes a rotatable vane.

7. The dispenser of claim 5, wherein the flow restricting means is substantially removable from the main flow path.

8. A liquid container adapted for use with the dispenser of claim 1, the liquid container being engageable, in use, with a base of the dispenser and provided with a first chamber, at least one inlet port in fluid communication with the first chamber and adapted to communicate with the outlet means when the base and liquid container are engaged, and at least one outlet port in fluid communication with the first chamber and adapted to communicate with the inlet means when the base and liquid container are engaged.

9. The liquid container of claim 8 provided with a dividing member which is slideably and sealingly engaged with an inner surface of the liquid container, the dividing member provided between the inlet port and the outlet port.

10. The liquid container of claim 8 provided with a plurality of inlet ports.

11. A dispenser for dispensing a liquid additive into a stream of liquid, the dispenser provided with a main flow passage for the stream of liquid, the main flow passage having a main flow inlet, a main flow outlet, and a main flow restricting means between the main flow inlet and the main flow outlet, the dispenser provided with a first chamber for containing the liquid additive, the first chamber having a first volume, an inlet conduit connecting the main flow passage, between the main flow inlet and the main flow restricting means, with the first chamber, the inlet conduit having a second volume which is greater than said first volume, and an outlet conduit connecting the first chamber with the main flow passage, between the main flow outlet and the main flow restricting means, wherein, in use, fluid from the main flow passage entering the inlet conduit forces air in the inlet conduit into the first chamber, thereby displacing the liquid additive through the outlet conduit.

12. The dispenser of claim 11, wherein substantially all of a liquid additive contained in the first chamber is displaced from the first chamber before the first conduit is completely filled with fluid from the main flow passage.

13. The dispenser of claim 11, including a base engageable with a liquid additive container, wherein the first chamber is provided in the liquid additive container and the main flow passage is provided in the base.

14. The dispenser of claim 11, wherein the restriction caused by the main flow restricting means is adjustable.

15. The dispenser of claim 14, wherein the flow restricting means is removable from the main flow path.

16. A dispenser for dispensing a liquid additive into a stream of liquid, the dispenser including a base engageable in use with a liquid additive container by relative movement of the liquid additive container toward the base along an engagement axis, the liquid additive container provided with a first chamber for containing the liquid additive, the dispenser provided with a main flow passage for the stream of liquid, the main flow passage having a main flow inlet, a main flow outlet, and a main flow restricting means between the main flow inlet and the main flow outlet, the base provided with an outlet means and an inlet conduit connecting the main flow passage, between the main flow inlet and the main flow restricting means, with the outlet means, the base further provided with an inlet means and an outlet conduit connecting the main flow passage, between the main flow outlet and the main flow restricting means, with the inlet means, the liquid container including an inlet port adapted to communicate with the outlet means when the base and liquid container are engaged, and an outlet port adapted to communicate with the inlet means when the base and liquid container are engaged, wherein at least one of the inlet means and the outlet means of the base are provided in a surface of base which is substantially parallel to the engagement axis, and wherein a volume of the inlet conduit is greater than a volume of the first chamber.

17. The dispenser of claim 16 wherein, in use, substantially all of a liquid additive contained in the first chamber is displaced from the first chamber before the inlet conduit is completely filled with fluid from the main flow passage.

18. The dispenser of claim 16, wherein the restriction caused by the main flow restricting means is adjustable.

19. The dispenser of claim 18, wherein the flow restricting means is removable from the main flow path.

20. A method of filling a liquid additive container having a chamber, an inlet port and an outlet port connected to the chamber and a dividing member which is slideably and sealingly engaged with an inner surface of the liquid container between the inlet port and the outlet port, the method including the steps of:
i. applying a vacuum to the outlet port;
ii. maintaining the vacuum until the dividing means has moved to a position wherein the volume of the chamber between the dividing means and the outlet port is minimised;
iii. inserting a required volume of liquid additive into the chamber through the outlet port.

21. The method of claim 20, including a step of sealing the inlet and outlet ports after the step of inserting the required volume of liquid additive is complete.

22. The method of claim 21, wherein the step of sealing the inlet and outlet ports is performed by sealing with a single sealing means.

23-24. (canceled)
